(19) United States
(12) Patent Application Publication
(10) Pub. No.: US 2006/0090296 A1
(43) Pub. Date: May 4, 2006

(54) Sprung hinge for supporting closure elements

(75) Inventor: Daniele Zetti, Modena (IT)

Correspondence Address: MODIANO & ASSOCIATI, Via Meravigli, 16, Milan, 20123, IT

(73) Assignee: T.G.N. S.P.A.

(21) Appl. No.: 11/252,600

(22) Filed: Oct. 19, 2005

(30) Foreign Application Priority Data
Oct. 29, 2004 (IT) MO2004A000288

(51) Int. Cl. E05F 1/08

(52) U.S. Cl. 16/302; 16/303

(57) ABSTRACT

A sprung hinge for supporting closure elements comprising a first articulated quadrilateral and a second articulated quadrilateral, sharing a first and a second levers and having, as base element, respectively a plate for coupling to a component intended to be fixed and a plate for fixing to a closure element, at least first elastic elements, acting on at least one of the articulated quadrilaterals, and an auxiliary plate for coupling to the component, the auxiliary and the fixing plates being arranged on planes substantially mutually parallel in the hinge closure configuration, the auxiliary plate being arranged on a plane substantially perpendicular to the plane formed by the coupling plate.

The present invention relates to a sprung hinge for supporting closure elements.

### BACKGROUND OF THE INVENTION

The hinge according to the present invention is applied particularly but not exclusively for the articulation of closure elements, such as for example the doors of pieces of furniture or of cabinets of caravans, campers or the like, which in passing from the closed configuration to the open configuration and vice versa rotate about a substantially horizontal axis.

With reference to the doors of wall-mounted cabinets, for example of caravans, campers or certain kitchens, they are generally arranged on the vertical plane when they are in the closed configuration and on a horizontal or inclined plane when they are in the open configuration.

Sprung hinges are known which are provided with a double articulated quadrilateral and with two enclosed springs which are arranged in series or in parallel and act on mutually opposite parts of respectively the two quadrilaterals or one of them.

The two articulated quadrilaterals share a first lever and a second lever and have, as their base elements, respectively a coupling plate, which is intended to be fixed to a fixed component of the piece of furniture, cabinet or the like, and a plate for fixing to the closure element.

The coupling plate and the fixing plate lie on mutually parallel planes when the hinge is in the closed configuration and on mutually perpendicular or inclined planes when the hinge is in the open configuration.

Again with reference to the doors of wall-mounted cabinets, the coupling plate is fixed to the internal vertical face of the horizontal side wall that delimits the cabinet in an upper region and the fixing plate is fixed to the face of the door which, in the closed configuration of the cabinet, faces its inside.

Fixing occurs by way of threaded means such as screws.

In some cases, known hinges are fixed to the component that is intended to be fixed and to the closure element before fitting said component and said element to the structure of the piece of furniture, cabinet or the like; in particular, the coupling plate is fixed to the fixed component before said fixed component is assembled to the structure of the piece of furniture, cabinet or the like.

In other cases, instead, the coupling plate of the hinge is fixed to the fixed component, which is already preassembled to the structure of the piece of furniture, cabinet or the like, and then the fixing plate is fixed to the closure element.

In these last cases, drawbacks are encountered, including the fact that the operations for fixing the coupling plate to the fixed component are extremely awkward and laborious, due both to tight and limited maneuvering spaces and to a limited visual field, which prevent the fitter, for example, from centering precisely the holes for the passage of the screws or from screwing on said screws correctly.

Consider, for example, the case in which the coupling plate must be fixed to the internal vertical face of the horizontal side wall that delimits in an upper region a wall-mounted cabinet; the fitter cannot check visually his work and cannot handle correctly his tools unless he assumes postures that are extremely awkward and uncomfortable and in any case prevent correct assembly.

The fixing of the coupling plate and consequently of the entire hinge is therefore uncertain and unstable.

### SUMMARY OF THE INVENTION

The aim of the present invention is to eliminate the drawbacks mentioned above of known hinges, by providing a sprung hinge for supporting closure elements, which allows to facilitate and simplify assembly operations, particularly, the operations for fixing the coupling plate to the fixed component, even when said fixed component is already assembled to the structure of the piece of furniture, cabinet or the like.

An object of the present invention is to provide a sprung hinge for supporting closure elements that allows a fitter to check visually his work and to handle easily the required tools for correct and stable fixing in particular of the plate for coupling to the fixed component, even when said component is already assembled to the structure of the piece of furniture, cabinet or the like, and therefore of the entire hinge for secure support of the closure element.

Within this aim, another object of the present invention is to provide a sprung hinge that is simple, relatively easy to provide in practice, safe in use, effective in operation, and has a relatively low cost.

This aim and these and other objects that will become better apparent hereinafter are achieved by the present sprung hinge for supporting closure elements, which comprises a first articulated quadrilateral and a second articulated quadrilateral, which share a first lever and a second lever and have, as their base element, respectively a plate for coupling to a component intended to be fixed and a plate for fixing to a closure element, said coupling plate and said fixing plate being arranged on planes which are mutually substantially parallel in the hinge closure configuration, and at least first elastic means, which act on at least one of said articulated quadrilaterals, said hinge being characterized in that it comprises an auxiliary plate for coupling to said component, said auxiliary plate being arranged on a plane which is substantially perpendicular to the plane formed by said coupling plate.

### BRIEF DESCRIPTION OF THE DRAWINGS

Further characteristics and advantages of the present invention will become better apparent from the following detailed description of a preferred but not exclusive embodiment of a sprung hinge for supporting closure elements, illustrated by way of non-limiting example in the accompanying drawings, wherein:

FIG. 1 is a schematic side view of a hinge according to the invention, applied to a closure element in the open configuration;

FIG. 2 is a schematic top plan view of a hinge according to the invention;

FIG. 3 is a schematic sectional view of FIG. 1;

FIG. 4 is a schematic sectional view of the hinge according to the invention, applied to a closure element, in the closed configuration;

FIG. 5 is a schematic side view of the coupling plate of the hinge according to the invention;

FIG. 6 is a schematic plan view of the coupling plate of FIG. 5;

FIG. 7 is a schematic side view of the auxiliary coupling plate of the hinge according to the invention;

FIG. 8 is a schematic plan view of the auxiliary coupling plate of FIG. 7;

FIG. 9 is a schematic plan view of a first centering template of the hinge according to the invention, intended to be associated with the coupling plate;

FIG. 10 is a schematic plan view of a second centering template of the hinge according to the invention, intended to be associated with the auxiliary coupling plate;

FIG. 11 is a schematic side view of the first lever of the hinge according to the invention;

FIG. 12 is a schematic plan view of the first lever of FIG. 11;

FIG. 13 is a schematic side view of the second lever of the hinge according to the invention;

FIG. 14 is a schematic plan view of the second lever of FIG. 13.

### DESCRIPTION OF THE PREFERRED EMBODIMENTS

With reference to the figures, the reference numeral 1 generally designates a sprung hinge for supporting closure elements.

The hinge 1 comprises a first articulated quadrilateral and a second articulated quadrilateral, which share a first lever 2 and a second lever 3 and have, as their base element, respectively a plate 4 for coupling to a component 5 that is intended to be fixed and a plate 6 for fixing to a closure element 7 which is substantially plate-like.

Particularly but not exclusively with reference to wall-mounted cabinets, the component 5 may be constituted by the horizontal side wall which delimits said cabinet in an upper region, while the closure element 7 may be constituted by the corresponding door.

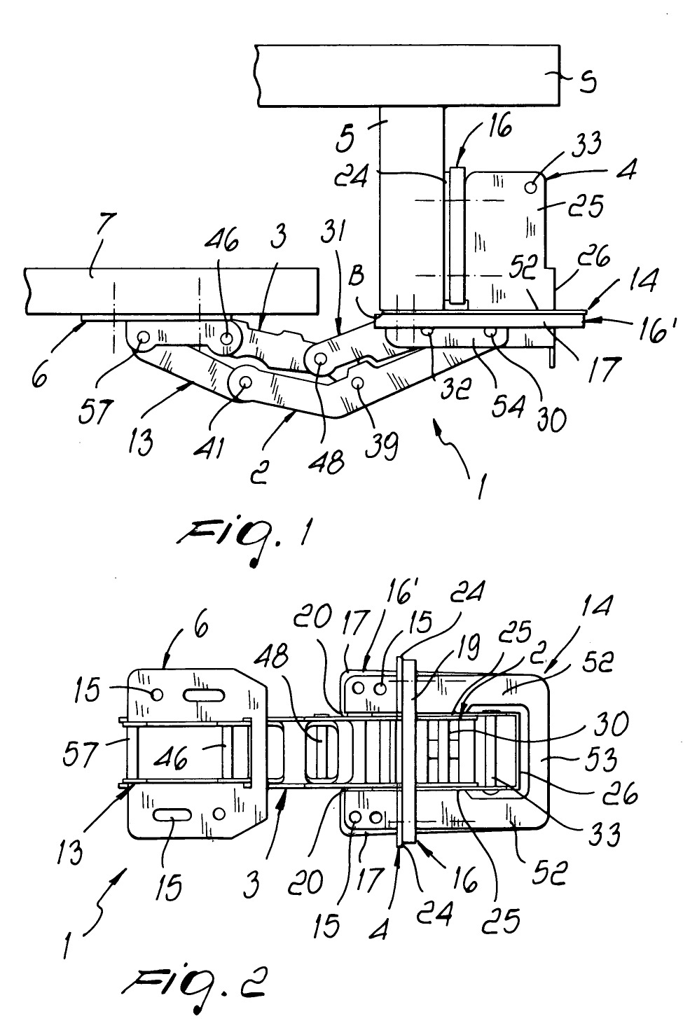

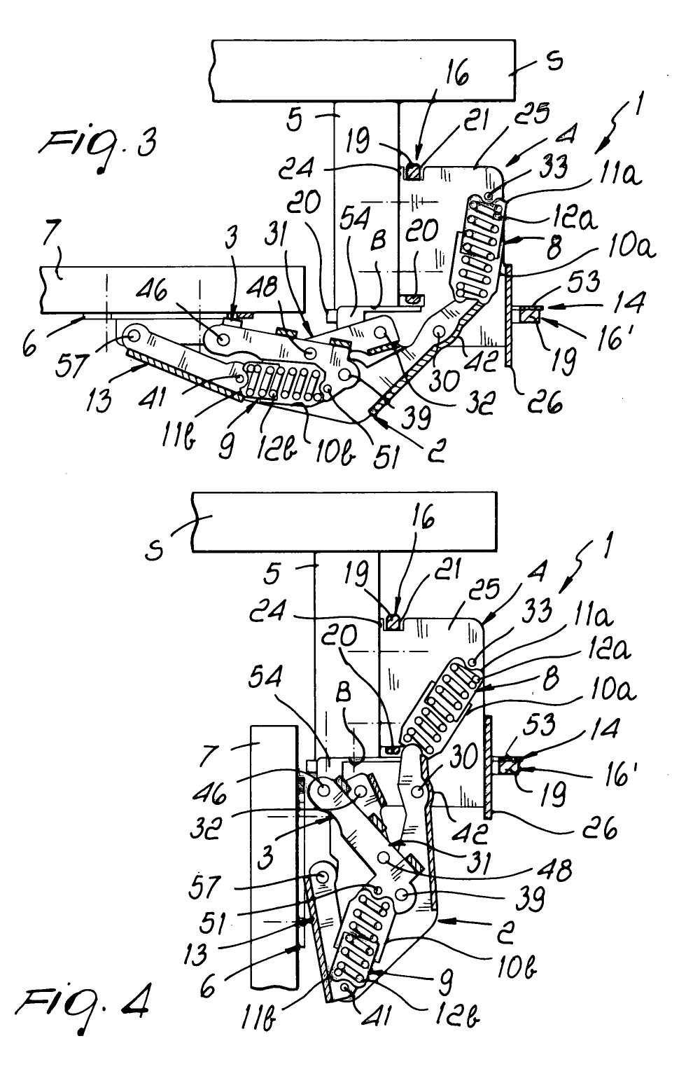

The coupling plate 4 and the fixing plate 6, when the hinge 1 is in the closed configuration, lie on mutually substantially parallel planes (FIG. 4), while the closure element 7, in passing from the closed configuration to the open configuration and vice versa, rotates about a substantially horizontal axis (FIGS. 1, 3 and 4).

In the particular embodiment shown in the figures cited above, the hinge 1 comprises first elastic means 8 and second elastic means 9, which are arranged in series and act on mutually opposite points of the first and second articulated quadrilaterals respectively.

The first and second elastic means 8 and 9 are of the type of elastic telescopic caps and are constituted respectively by two mutually opposite elements, which can slide with respect to each other and act as a guide and support for a spring; in particular, the two mutually opposite elements are constituted by bottoms 10a and 10b and by tops 11a and 11b, between which a respective spring 12a and 12b is contained.

In the first elastic means 8, the top 11a is associated with the coupling plate 4 and the bottom 10a is associated with the first lever 2.

In the second elastic means 9, the top 11b is associated with an arm 13 and the bottom 10b is associated with the second lever 3.

However, it is also possible to provide alternative embodiments, not shown, in which the hinge 1 can comprise third elastic means arranged in parallel with the first elastic means 8 and/or the second elastic means 9, and in these cases the second elastic means 9 and the first elastic means 8 may be omitted respectively.

The hinge 1 further comprises an auxiliary plate 14 for coupling to the component 5, which lies on a plane which is substantially perpendicular to the plane formed by the coupling plate 4; said auxiliary plate allows to fix the hinge to the lower edge B of the component 5 instead of fixing it to one of its opposite faces.

The coupling plate 4, the fixing plate 6 and the auxiliary coupling plate 14 comprise respective fixing holes or slots 15 for the insertion of threaded fixing means, such as screws, the corresponding axes of which have been shown by means of a dashed line.

The hinge 1 further comprises one or more templates 16 for centering the holes 15; said templates can be associated by superimposition with the coupling plate 4, the fixing plate 6 and the auxiliary coupling plate 14.

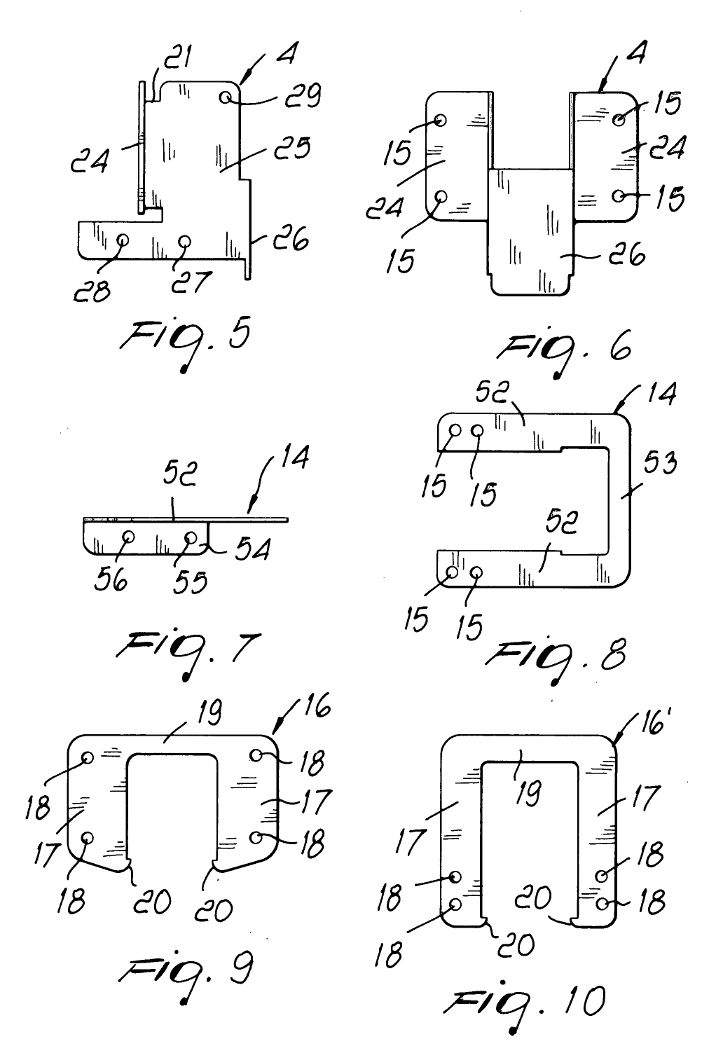

The templates 16 (FIGS. 9 and 10) are substantially U-shaped or the like and comprise two arms 17, which are mutually substantially parallel and in which centering holes 18 for centering the holes 15 are formed; the two arms 17 are rigidly coupled to each other at one end by a transverse element 19.

The threaded fixing means (screws) can be preassembled to the centering holes 18 and can be self-tapping with respect to them.

The arms 17 have, at their respective free ends, a corresponding tooth 20 for engaging the coupling plate 4, the fixing plate 6 or the auxiliary coupling plate 14; said plates can be provided with recesses 21 for accommodating the transverse element 19 of the corresponding template 16.

Conveniently, the transverse element 19 can flex in the direction for mutual spacing/approach of the arms 17 so as to allow easy application of the templates 16 to the plates.

In the illustrated embodiment, the hinge 1 comprises a first template 16, which is associated with the coupling plate 4, and a second template 16′, which is associated with the auxiliary coupling plate 14.

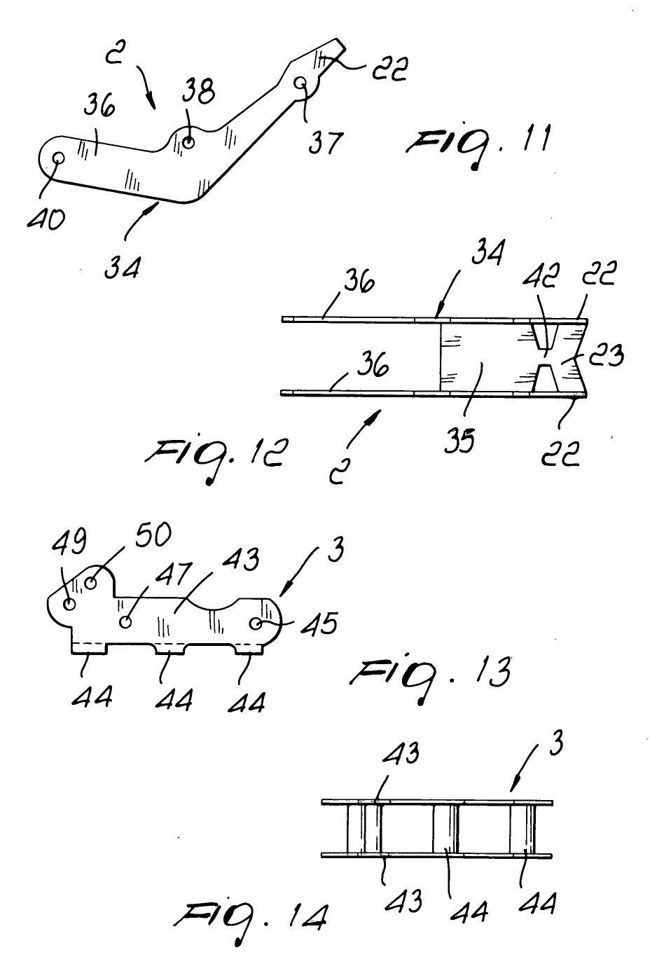

The first lever 2 (FIGS. 11 and 12) has an end which is extended by two lug-shaped tabs 22 toward the coupling plate 4 and is articulated to the bottom 10a in order to receive the thrust of the first elastic means 8.

The ends of the lug-shaped tabs 22 are mutually connected by a connecting bridge 23, which is monolithic with said tabs and is coupled rotationally to the bottom 10a of the first elastic means 8.

Advantageously, the upper edge of the connecting bridge 23 is shaped for coupling to a corresponding lower recess formed in the bottom 10a.

The coupling plate 4 (FIGS. 5 and 6) is constituted by two fixing bases 24, in which the holes 15 are provided and from which respective side walls 25 extend, said side walls being mutually connected by a lower bridge 26, which is offset and protrudes.

A respective recess 21 for accommodating the transverse element 19 of the respective template 16 is formed in each one of the two side walls 25.

Three holes are formed on each side wall 25: two lower ones 27 and 28, formed at the bridge 26, and an upper one 29, formed in an opposite position with respect to the lower holes 27 and 28.

The holes 27 of the two side walls 25 that lie proximate to the bridge 26 allow articulated coupling between the coupling plate 4 and the first lever 2 at the pivot 30; the holes 28, which lie further away with respect to the bridge 26, allow the articulated connection of the coupling plate 4 to an arm 31 at the pivot 32.

A pivot 33 is inserted in the upper holes 29 and is coupled rotationally to the top 11a; the first elastic means 8 therefore act between the pivot 33 and the connecting bridge 23 and transmit the thrust to the first lever 2.

The first lever 2 is constituted by a single body provided with two side walls 34, which are interconnected by a central bridge 35 and are provided with respective arms 36, which protrude on the opposite side with respect to the lug-shaped tabs 22.

Each side wall 34 is provided with at least three holes: a first hole 37, which is formed proximate to the tab 22 for the insertion of the pivot 30 that articulates the first lever 2 to the coupling plate 4, a second intermediate hole 38 for the insertion of a pivot 39 for the articulation of the first lever 2 to the second lever 3, and a third end hole 40, which is formed in the arm 36 for the articulated coupling of the first lever 2 to the arm 13 in the pivot 41.

The connecting bridge 23 is connected to the central bridge 35 by a contoured band 42, which is coupled rotationally to the pivot 30.

The second lever 3 (FIGS. 13 and 14) is constituted by two side walls 43, which are interconnected by dorsal bridges 44 and on which four holes are formed: an end hole 45 for the insertion of a pivot 46 for the articulation of the second lever 3 to the fixing plate 6, a hole 47 for the insertion of a pivot 48 for coupling between the second lever 3 and the arm 31, a hole 49 in which the pivot 39 is inserted, and finally a hole 50, in which it is possible to insert a pivot 51, which couples rotationally to the bottom 10b of the second elastic means 9.

As an alternative, the pivot 51 can be replaced by a ventral bridge, not illustrated here.

In the second elastic means 9, the top 11b is articulated to the pivot 41: said means therefore act between the arm 13 and the second lever 3 and rest respectively on the pivots 41 and 51 and transmit the thrust to the first lever 2 about the pivot 39.

The auxiliary coupling plate 14 (FIGS. 7 and 8) is substantially U-shaped and has two longitudinal elements 52, which are mutually substantially parallel, surround externally the side walls 25 of the coupling plate 4 and are mutually connected, at one end, by a cross-member 53, which is arranged proximate to the bridge 26 of the coupling plate 4.

The fixing holes 15 for fixing to the lower edge B the component 5 are formed on the two longitudinal elements 52.

A respective side wall 54 protrudes below each one of the two longitudinal elements 52 and is provided with two side holes or slots 55 and 56, which allow to fix it to the side walls 25 of the coupling plate 4 at the holes 27 and 28 thereof by virtue of the pivots 30 and 32.

The first articulated quadrilateral is constituted by the coupling plate 4, the arm 31, the second lever 3 and the first lever 2, which are articulated respectively about the pivots 32, 48, 39 and 30; the second articulated quadrilateral is constituted by the fixing plate 6, the arm 13, the first lever 2 and the second lever 3, which are articulated respectively about the pivots 57, 41, 39 and 46.

The actions applied by the first elastic means 8 to the connecting bridge 23 and the actions applied by the second elastic means 9 to the pivot 51 are developed on the first lever 2.

The first lever 2 is formed as a single part whose length is such as to form an arm which is long enough to integrate the supporting thrust of the closure element 7, supporting in particular its weight when it is in the horizontal configuration with respect to the component 5, which is fixed and vertical.

With particular but not exclusive reference to the fitting of the hinge 1 to a cabinet, for example a wall-mounted cabinet of a caravan, camper or kitchen, the component 5 is constituted by the upper horizontal side wall, which delimits the cabinet and the closure element 7 is constituted by the respective closure door.

If it is necessary to fit the hinge 1 on the component 5 which has already been preassembled to the structure S of the cabinet, the auxiliary coupling plate 14 allows to fix the hinge 1 to the lower edge B of the component 5 instead of fixing to its internal vertical face, allowing the fitter to check his work visually and to manipulate with great freedom the necessary tools simply and easily.

Further, with the aid of the templates 16 the centering of the holes 15 and therefore the assured and stable fitting of the hinge 1 are facilitated.

In practice it has been found that the described invention achieves the proposed aim and objects.

The invention thus conceived is susceptible of numerous modifications and variations, all of which are within the scope of the appended claims.

All the details may further be replaced with other technically equivalent ones.

In practice, the materials used, as well as the shapes and the dimensions, may be any according to the requirements without thereby abandoning the scope of the protection of the appended claims.

The disclosures in Italian Patent Application No. MO2004A000288 from which this application claims priority are incorporated herein by reference.

What is claimed is:

1. A sprung hinge for supporting closure elements, comprising: a first articulated quadrilateral; a second articulated quadrilateral, said first and second articulated quadrilaterals sharing a first lever and a second lever and having a base element, formed by a coupling plate for coupling to a component to be fixed and a fixing plate for fixing to a closure element, said coupling plate and said fixing plate being arranged on arrangement planes which are mutually substantially parallel in a hinge closure configuration; first elastic means, which act on at least one of said first and second articulated quadrilaterals; an auxiliary plate for coupling to the component, said auxiliary plate being arranged on a plane which is substantially perpendicular to the arrangement plane of said coupling plate.

2. The hinge of claim 1, further comprising second elastic means, which act on the other one of said first and second articulated quadrilaterals in series to said first elastic means.

3. The hinge of claim 2, comprising third elastic means, which act in parallel with at least one of said first and second elastic means.

4. The hinge of claim 1, wherein said coupling plate, said fixing plate and said auxiliary coupling plate comprise insertion holes for insertion therein of threaded fixing means.

5. The hinge of claim 4, wherein said auxiliary coupling plate is substantially U-shaped.

6. The hinge of claim 5, wherein said auxiliary coupling plate comprises two longitudinal elements which are mutually substantially parallel and coplanar so as to lay on said substantially perpendicular plane, a cross-member that connects said longitudinal elements at a first end thereof, and fixing holes being formed in said longitudinal elements.

7. The hinge of claim 6, wherein said auxiliary coupling plate comprises, below each one of said longitudinal elements, a respective side wall and side holes or slots for fixing to said coupling plate formed in said side wall.

8. The hinge of claim 7, comprising at least one template for centering said fixing holes, said at least one template being associatable by superimposition with at least one among said coupling plate, said fixing plate and said auxiliary coupling plate.

9. The hinge of claim 8, wherein said at least one template is substantially U-shaped.

10. The hinge of claim 9, wherein said at least one template comprises two template arms which are mutually substantially parallel with centering holes formed therein for centering said fixing holes of the plates, and a transverse element, said template arms being mutually rigidly coupled at one end thereof by said transverse element, centering holes being adapted for preassembly of the threaded fixing means.

11. The hinge of claim 10, wherein said template arms have, at respective free ends thereof, a corresponding tooth for engagement with said coupling plate, said fixing plate or said auxiliary coupling plate.

12. The hinge of claim 11, wherein at least one among said coupling plate, said fixing plate and said auxiliary coupling plate is provided with recesses for accommodating said transverse element of the corresponding said at least one template.

13. The hinge of claim 12, wherein said transverse element is flexible in a direction for the mutual spacing/approach of said template arms.
